(19) United States
(12) Patent Application Publication
(10) Pub. No.: US 2009/0225877 A1
(43) Pub. Date: Sep. 10, 2009

(54) METHOD AND SYSTEM FOR CHARACTERIZATION OF FILTER TRANSFER FUNCTIONS IN OFDM SYSTEMS

(76) Inventors: Francis Swarts, San Diego, CA (US); Mark Kent, Vista, CA (US); Theodoros Georgantas, Chaidari (GR)

Correspondence Address: MCANDREWS HELD & MALLOY, LTD, 500 WEST MADISON STREET, SUITE 3400, CHICAGO, IL, 60661, US

(21) Appl. No.: 12/251,815

(22) Filed: Oct. 15, 2008

Related U.S. Application Data
(60) Provisional application No. 61/033,489, filed on Mar. 4, 2008.
(60) Provisional application No. 61/092,944, filed on Aug. 29, 2008.

(51) Int. Cl. H04L 27/28

(52) U.S. Cl. 375/260

(57) ABSTRACT

Aspects of a method and system for characterization of filter transfer functions in OFDM systems may include receiving at a filter, a calibration signal which is generated from conversion of a digital input signal comprising N samples to an analog signal. The digital input signal may comprise one (1) full scale sample and N-1 zero samples and N is an integer. In response to receiving the calibration signal, the filter may generate an output analog signal, wherein the output analog signal may be converted to an output digital signal, and a transfer function of the filter may be determined via a Fast Fourier transformation of the output digital signal. The OFDM system may be compliant with a wireless standard, wherein the wireless standard may comprise UMTS EUTRA (LTE), WiMAX(IEEE 802.16), and/or WLAN (IEEE 802.11).

### CROSS-REFERENCE TO RELATED APPLICATIONS/INCORPORATION BY REFERENCE

This application makes reference to, claims priority to, and claims the benefit of U.S. Provisional Application Ser. No. 61/033,489, filed on Mar. 4, 2008 and U.S. application Ser. No. 61/092,944, filed on Aug. 29, 2008.

This application also makes reference to U.S. application Ser. No. ______ (Attorney Docket No. 19437US03), which is filed on even date herewith.

Each of the above referenced applications is hereby incorporated herein by reference in its entirety.

### FIELD OF THE INVENTION

Certain embodiments of the invention relate to wireless communication systems. More specifically, certain embodiments of the invention relate to a method and system for characterization of filter transfer functions in OFDM systems.

### BACKGROUND OF THE INVENTION

Mobile communications have changed the way people communicate and mobile phones have been transformed from a luxury item to an essential part of every day life. The use of mobile phones is today dictated by social situations, rather than hampered by location or technology. While voice connections fulfill the basic need to communicate, and mobile voice connections continue to filter even further into the fabric of every day life, the mobile Internet is the next step in the mobile communication revolution. The mobile Internet is poised to become a common source of everyday information, and easy, versatile mobile access to this data will be taken for granted.

Third (3G) and fourth generation (4G) cellular networks have been specifically designed to fulfill these future demands of the mobile Internet. As these services grow in popularity and usage, factors such as cost efficient optimization of network capacity and quality of service (QoS) will become even more essential to cellular operators than it is today. These factors may be achieved with careful network planning and operation, improvements in transmission methods, and advances in receiver techniques. To this end, carriers need technologies that will allow them to increase downlink capacity.

In order to meet these demands, communication systems may become increasingly complex and increasingly miniaturized. It may hence be important to strive for solutions that may reduce, for example, the system complexity while offering high performance.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method for characterization of filter transfer functions in OFDM systems substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating an exemplary wireless communication system, which may be utilized for characterization of filter transfer functions, in accordance with an embodiment of the invention.

FIG. 2A is a diagram of an exemplary analog OFDM receiver front end, which may be utilized for characterization of filter transfer functions, in accordance with an embodiment of the invention.

FIG. 2B is a diagram of an exemplary filter impulse response measurement setup for OFDM systems, in accordance with an embodiment of the invention.

FIG. 3 is a diagram of an exemplary double-sided frequency response with and without I/Q mismatch, in accordance with various embodiments of the invention.

FIG. 4 is a diagram of an exemplary double-sided phase response of an I branch filter and a Q branch filter mismatch, in accordance with an embodiment of the invention.

FIG. 5 is a flow chart illustrating a transfer function characterization, in accordance with various embodiments of the invention.

### DETAILED DESCRIPTION OF THE INVENTION

Certain embodiments of the invention may be found in a method and system for characterization of filter transfer functions in Orthogonal Frequency Division Multiplexing (OFDM) systems. Aspects of a method and system for characterization of filter transfer functions in OFDM systems may comprise receiving at a filter, a calibration signal which is generated from conversion of a digital input signal comprising N samples to an analog signal, wherein the digital input signal comprises one (1) full scale sample and N-1 zero samples and N is an integer. In response to receiving the calibration signal, the filter may generate an output analog signal, wherein the output analog signal may be converted to an output digital signal, and a transfer function of the filter may be determined via a Fast Fourier transformation of the output digital signal.

The OFDM system may be compliant with a wireless standard, wherein the wireless standard may comprise UMTS EUTRA (LTE), WiMAX (IEEE 802.16), and/or WLAN (IEEE 802.11). A transfer function of an in-phase branch filter and/or a quadrature branch filter may be measured. The filter may be an in-phase branch filter or a quadrature branch filter. The transfer function may comprise a magnitude and/or phase response, wherein the magnitude and/or phase response mismatch may be a function of frequency. A number of the samples N may be chosen arbitrarily. The calibration signal may approximate an impulse signal. The Fast Fourier transformation may be performed with an arbitrary number of coefficients.

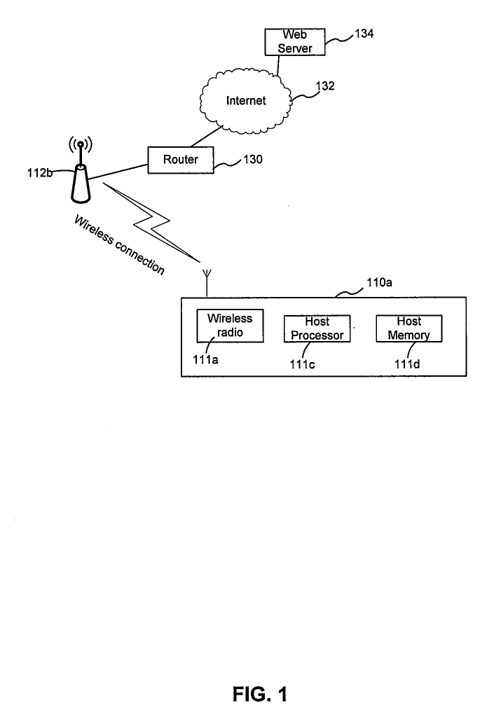

FIG. 1 is a diagram illustrating an exemplary wireless communication system, which may be utilized for characterization of filter transfer functions, in accordance with an embodiment of the invention. Referring to FIG. 1, there is shown an access point 112b, a computer 110a, a router 130, the Internet 132 and a web server 134. The computer or host device 110a may comprise a wireless radio 111a, a host processor 111c, and a host memory 111d. There is also shown a wireless connection between the wireless radio 111a and the access point 112b.

The access point 112b may comprise suitable logic, circuitry and/or code that may be enabled to transmit and receive radio frequency (RF) signals for data communications, for example with the wireless radio 111a. The access point 12b may also be enabled to communicate via a wired network, for example, with the router 130. The wireless radio 11a may comprise suitable logic, circuitry and/or code that may enable communications over radio frequency waves with one or more other radio communication devices. The wireless radio 111a and the access point 112b may be compliant with one or more communication standards, for example, GSM, UMTS EUTRA (LTE), CDMA2000, Bluetooth, WiMAX (IEEE 802.16), and/or IEEE 802.11 Wireless LAN.

The host processor 111c may comprise suitable logic, circuitry and/or code that may be enabled to generate and process data. The host memory 111d may comprise suitable logic, circuitry and/or code that may be enabled to store and retrieve data for various system components and functions of the computer 110a.

The router 130 may comprise suitable logic, circuitry and/or code that may be enabled to communicate with communication devices that may be communicatively coupled to it, for example the access point 112b and/or one or more communication devices that may be communicatively coupled to the Internet 132.

The Internet 132 may comprise suitable logic, circuitry and/or code that may be enabled to interconnect and exchange data between a plurality of communication devices. The web server 134 may comprise suitable logic, circuitry and/or code that may be enabled to communicate with communication devices that may be communicatively coupled to it via, for example the Internet 132.

Various computing and communication devices comprising hardware and software may be enabled to communicate using one or more wireless communication standards and/or protocols. For example, a user of the computer or host device 110a may access the Internet 132 in order to consume streaming content from the Web server 134. Accordingly, the user may establish a wireless connection between the computer 110a and the access point 112b. Once this connection is established, the streaming content from the Web server 134 may be received via the router 130, the access point 112b, and the wireless connection, and consumed by the computer or host device 110a.

In many communication devices, the in-phase (I) channel and the quadrature (Q) channel may be processed separately. Because of component variation, and/or slight mismatch due to fixed hardware that may be operated on multiple communication protocols and/or frequencies, there may be instances when the I-channel and Q-channel processing chains may not be identical. This mismatch may affect communication performance. Various embodiments of the invention may be operable to compensate for mismatch between the I-channel and Q-channel, in accordance with various embodiments of the invention. In this regard, a transfer function mismatch between an in-phase processing branch, and/or a quadrature processing branch of an OFDM receiver may be determined. To determine transfer function mismatch, the transfer functions may be measured. In this regard, a calibration signal may be received at a filter. The calibration signal may be generated from conversion of a digital input signal comprising N samples to an analog signal, wherein the digital input signal comprises one (1) full scale sample and N-1 zero samples and N is an integer. In accordance with various embodiments of the invention, in some instances, the N-1 zero samples may be generated by grounding the filter input. In response to receiving the calibration signal, the filter may generate an output analog signal, wherein the output analog signal may be converted to an output digital signal, and a transfer function of the filter may be determined via a Fast Fourier transformation of the output digital signal.

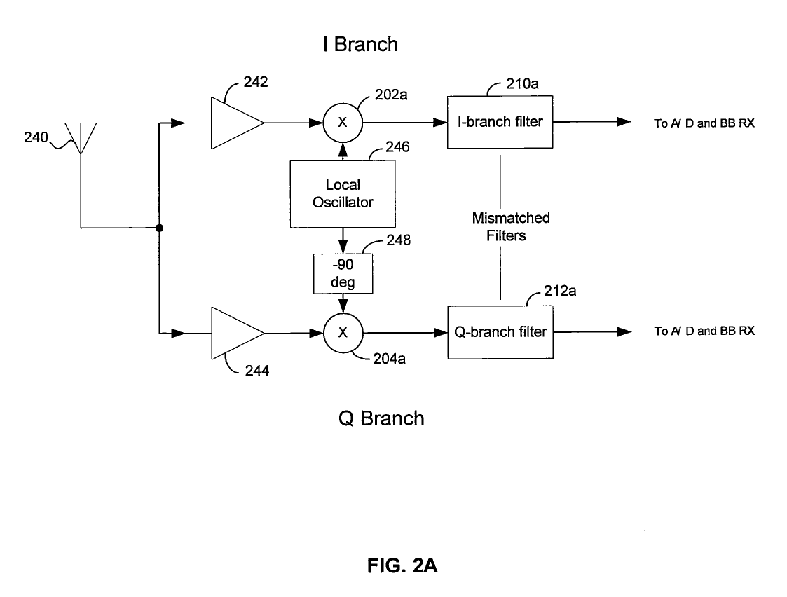

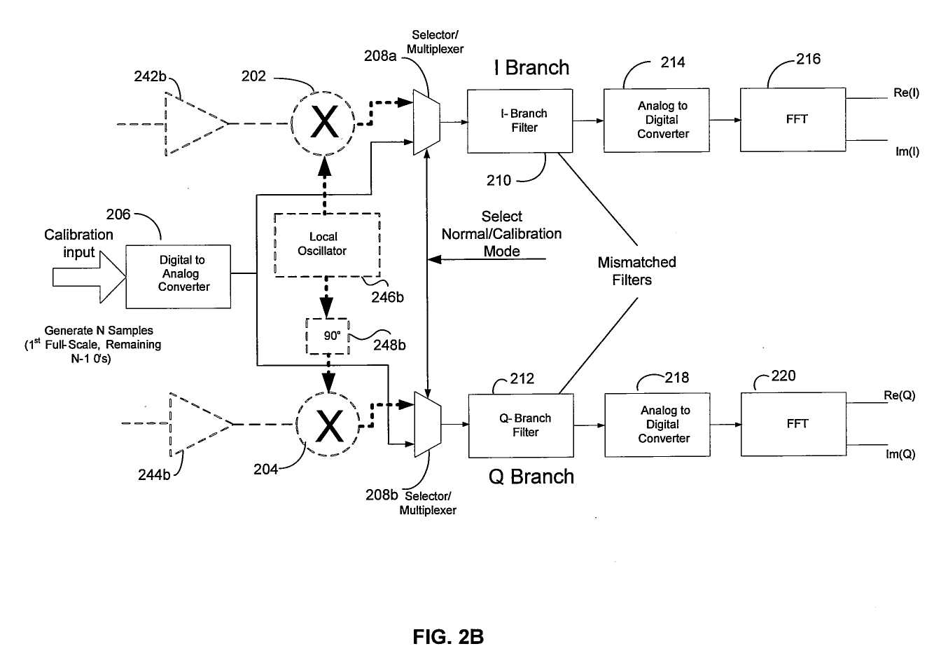

FIG. 2A is a diagram of an exemplary analog OFDM receiver front end, which may be utilized for characterization of filter transfer functions, in accordance with an embodiment of the invention. Referring to FIG. 2A, there is shown an antenna 240, amplifiers 242 and 244, multipliers or mixers 202a and 204a, a local oscillator 246, a phase shifting block 248, and in-phase (I) branch filter 210a, and a quadrature (Q) branch filter 212a.

The antenna 240 may comprise suitable logic, circuitry and/or code that may be enabled to convert electromagnetic radio-frequency waves to electrical signal. The amplifier 242 may comprise suitable logic, circuitry and/or code that may be enabled to amplify and/or filter an input signal. The amplifier 244 may be substantially similar to amplifier 242.

The multiplier 202a may comprise suitable logic, circuitry and/or code that may be enabled to generate an output signal that may be proportional to the product of a plurality of input signals. The multiplier 204a may be substantially similar to the multiplier 202a. The local oscillator 246 may comprise suitable logic, circuitry and/or code that may be enabled to generate a alternating current (AC) and/or voltage signal. This AC signal may, for example, be a sinusoidal signal.

The phase shifting block 248 may comprise suitable logic, circuitry and/or code that may be enabled to generate an output signal that may be a phase shifted version of the phase shifting block 248 input signal. The I-branch filter 210a may comprise suitable logic, circuitry and/or code that may be enabled to attenuate certain frequency components of an input signal and/or a phase of an input signal. The Q-branch filter 212a may be substantially similar to the I-branch filter 212a.

In most instances, OFDM wireless communication systems may employ complex valued signals that may be processed as two separate, real-valued signal branches/paths, I branch and the Q branch, as illustrated in FIG. 2A. One signal branch may process the in-phase (I) signal component, and the other signal branch may process the quadrature (Q) signal component. Signal processing elements in the analog front-end of an OFDM receiver may comprise one or more amplifiers 242 and 244, mixers/multipliers 202a and 204a, and filters 210a and 212a. The processing elements in the analog front-end of the receiver may appear in pairs for processing of signals along the I and Q branches, respectively, as illustrated in FIG. 2A. The pairs of signal processing elements may have similar, matching characteristics, for example gain, bandwidth, phase, and/or magnitude response, in accordance with various embodiments of the invention, and depending on specific components used. However, component imperfections and manufacturing tolerances in discrete components and/or integrated circuits may lead to mismatches in, for example, I-branch filter 210a and Q-branch filter 212a that may have signal transfer characteristics that may not perfectly match. Such transfer function mismatches may lead to differences in signal processing between the I and Q branches of the receiver, which in turn may degrade receiver performance, for example bit error rate performance.

In some instances, mismatches that may exist between I and Q branch elements, for example I-branch filter 210a and Q-branch filter 212a, or amplifiers 242 and 244, may be compensated for by using equalizing techniques, which may significantly reduce mismatches. However, for effective equalization, the sources of mismatch may be characterized, to appropriately adjust the equalizer. In accordance with various embodiments of the invention, the I and Q branch filter 210a and 212a impulse transfer functions may be characterized. For example, FIG. 2A may illustrate an exemplary, simplified block diagram of an analogue RF front-end for an OFDM receiver. In accordance with an embodiment of the invention, it may be desirable to determine the frequency response of the I branch filter 210a, and the Q branch filter 212a. The I and/or Q branch characterization may be used to assist equalizing the I and/or Q branch mismatches.

FIG. 2B is a diagram of an exemplary filter impulse response measurement setup for OFDM systems, in accordance with an embodiment of the invention. Referring to FIG. 2B, there is shown amplifiers 242b and 244b, multipliers 202 and 204, a digital-to-analog converter 206, selectors or multiplexers 208a, and 208b, a local oscillator 246b, a phase shifting block 248b, an I-branch filter 210 and a Q-branch filter 212, analog-to-digital converters 214 and 218, and FFT blocks 216 and 220. There is also shown a calibration input signal, a normal/calibration mode selection signal, a real FFT in-phase output Re(I), an imaginary FFT in-phase output Im(I), a real FFT quadrature output Re(Q), and an imaginary FFT quadrature output Im(Q).

The amplifiers 242b and 244b, the multipliers 202 and 204, the phase shifting block 248b, the local oscillator 246b, the I-branch filter 210, and the Q-branch filter 212 may be substantially similar to the amplifiers 242 and 244, the multipliers or mixers 202a and 204a, the phase shifting block 248, the local oscillator 246, the I-branch filter 210a, and the Q-branch filter 212a, respectively, as described with respect to FIG. 2A.

The digital-to-analog (D/A) converter 206 may comprise suitable logic, circuitry and/or code that may be enabled to convert a digital input signal into an analog output signal. The analog-to-digital (A/D) converter 214 and 218 may comprise suitable logic, circuitry and/or code that may be enabled to convert an analog input signal into a digital representation output signal. The selector or multiplexer 208 may comprise suitable logic, circuitry and/or code that may be enabled to switch a plurality of input signals through to one or more outputs. The FFT block 216 and 220 may comprise suitable logic, circuitry and/or code that may be enabled to compute an FFT of an input signal.

In accordance with various embodiments of the invention, FIG. 2B may illustrate an analog front-end section of an OFDM receiver, where the outputs from the quadrature demodulators via multipliers 202 and 204 may be bypassed, and a digital-to-analog (D/A) converter 206 output may be switched to the I branch and/or Q branch analog filter inputs by means of the selectors or multiplexers 208a, and 208b. Because the analog front-end components, amplifiers 242b and 244b, multipliers or mixers 202 and 204, local oscillator 246b, and phase shifting block 248b may not be active during the transfer function characterization phase, they may be depicted in dashed lines. For characterization of the transfer functions of the I-branch filter 210 and/or the Q-branch filter 212, the calibration signal may be switched to the outputs of the multiplexer 208 via the selectors 208a and 208b, which may be controlled by the normal/calibration mode selection signal, for example. The outputs of the selectors or multiplexers 208a and 208b may be communicatively coupled to the input of the I-branch filter 210 and the Q-branch filter 212, respectively.

For example, a series of N samples may be sent to the D/A converter 206 input, of which the first sample may be a full-scale (with respect to D2A 206 input/output dynamic range) sample, the remaining N-1 samples may be zero, obtained either from the D/A 206 converter output, or by grounding the filter input. Such an input sequence to the D/A converter 206 may generate an output signal that may approximate a unit impulse function. An impulse function communicatively coupled to an I branch filter 210 and/or a Q branch filter 212 may be used to measure a transfer function of a filter.

For example, K samples may be taken at the I branch filter 210 output, for example, the first sample of which may coincide with the time when the first input sample was sent to the filter 210 input. A Fast Fourier Transform (FFT) of a set of output samples from the filter 210 may be computed via the Analog-to-Digital (A/D) converter 214, and the FFT block 216, generating the required transfer function of the filter 210 in the frequency-domain. Similarly, a transfer function may be determined for the Q-branch filter 212 by sending similar signal samples via the multiplexer to the filter 212, and by computing the filter transfer function via the A/D converter 218 and the FFT block 220. The Fast Fourier Transform in FFT block 216 and 220 may be performed with an arbitrary number of coefficients.

In accordance with various embodiments of the invention, the functional blocks that may be required to perform the transfer function characterization of the I branch filter 210 and/or the Q branch filter 212 may comprise elements of an OFDM transceiver, in particular the FFT blocks 216 and 220. Hence, the number or additional components to determine the transfer filter characteristics may be limited.

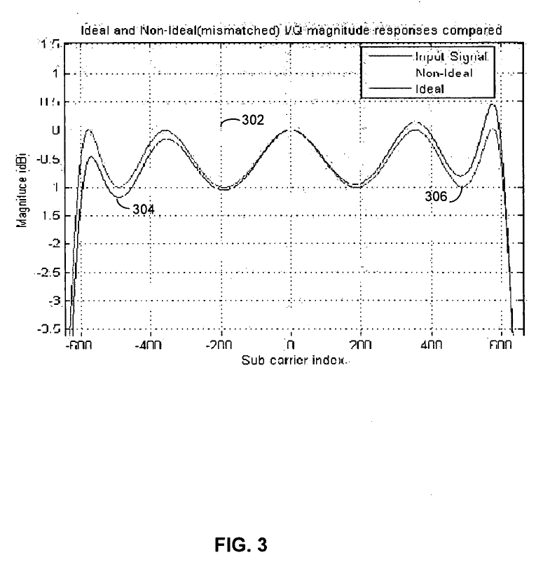

FIG. 3 is a diagram of an exemplary double-sided frequency response with and without I/Q mismatch, in accordance with various embodiments of the invention. There is shown an input signal 302, a non-ideal frequency response 304, and a near-ideal frequency response 306. The horizontal axis may illustrate OFDM sub-carriers (frequency) relative to DC level, and the vertical axis may illustrate magnitude. The plot in FIG. 3 may illustrate an exemplary magnitude transfer function that may be measured, in accordance with various embodiments of the invention.

It may be observed that the peak magnitudes of the near-ideal response 306 may approximately coincide with the input signal 302 magnitude, whereas the non-ideal response 304 magnitude peaks may be lower and/or higher than the input signal 302 magnitude.

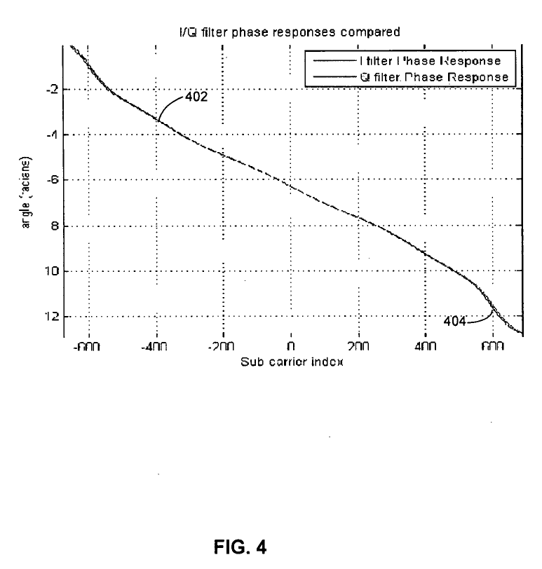

FIG. 4 is a diagram of an exemplary double-sided phase response of an I branch filter and a Q branch filter mismatch, in accordance with an embodiment of the invention. There is shown an I-branch filter phase response 402 and a Q-branch filter phase response 404. As illustrated in FIG. 4, the phase response may be similar but not precisely the same. Even small mismatches may in some circumstances deteriorate system performance. Thus, in accordance with various embodiments of the invention, a transfer function of the I branch filter and/or the Q branch filter may be characterized, for example, as described with respect to FIG. 2B.

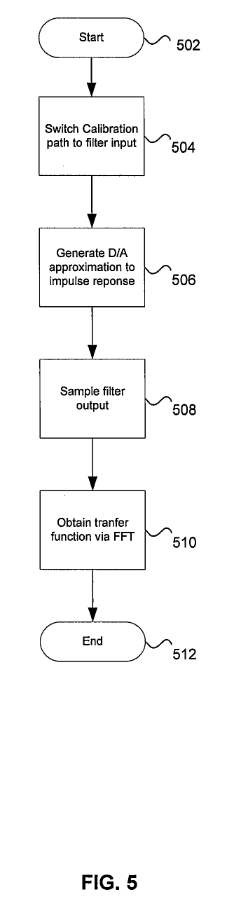

FIG. 5 is a flow chart illustrating a transfer function characterization, in accordance with various embodiments of the invention. After initialization in step 502, selectors or multiplexers, for example selectors or multiplexers 208a and 208b, may switch a calibration signal branch to its outputs in step 504. The outputs of the selectors or multiplexers 208a and 208b may be communicatively coupled to the input of an I branch filter 210 and/or to a Q branch filter 212, respectively. In step 506, for example, a digital impulse response calibration signal, comprising one full scale sample and N-1 zero samples, may be communicatively coupled to a D/A converter 206. The D/A converter 206 may be operable to generate an analog output signal, which may approximate a unit impulse function. The output signal of the D/A converter 206 may be communicated to the I branch filter 210 and/or the Q branch filter 212 via the multiplexers 208a and 208b. In step 508, the output of the I branch filter and/or Q branch filter in response to the calibration signal may be sampled, for example in the A/D converters 214 and 218. The sampled impulse response may, in step 510, be converted to the frequency domain by generating an FFT, for example in FFT blocks 216 and 220, of the samples generated in the A/D 214 and 218.

In accordance with an embodiment of the invention, a method and system for characterization of filter transfer functions in OFDM may comprise receiving at a filter, for example I branch filter 210, a calibration signal which is generated from conversion of a digital input signal comprising N samples to an analog signal in D/A converter 206. The filter may be an in-phase branch filter 210 or a quadrature branch filter 212. The calibration signal may approximate an impulse signal. The digital input signal may comprise one (1) full scale sample and N-1 zero samples and N is an integer. In response to receiving the calibration signal, the filter 210, for example, may generate an output analog signal, wherein the output analog signal may be converted to an output digital signal in the A/D converter 214, and a transfer function of the filter may be determined via a Fast Fourier transformation in the FFT block 216, for example, of the output digital signal. The Fast Fourier transformation may be performed with an arbitrary number of coefficients

The OFDM system may be compliant with a wireless standard, wherein the wireless standard may comprise UMTS EUTRA (LTE), WiMAX(IEEE 802.16), and/or WLAN (IEEE 802.11). A transfer function of an in-phase branch filter 210 and/or a quadrature branch filter 212 may be measured. The transfer function may comprise a magnitude and/or phase response, wherein the magnitude and/or phase response mismatch may be a function of frequency, as illustrated in FIG. 3 and FIG. 4. A number of the samples N may be chosen arbitrarily.

Another embodiment of the invention may provide a machine-readable and/or computer-readable storage and/or medium, having stored thereon, a machine code and/or a computer program having at least one code section executable by a machine and/or a computer, thereby causing the machine and/or computer to perform the steps as described herein for a method and system for characterization of filter transfer functions in OFDM.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing OFDMA signals, the method comprising:
receiving at a filter, a calibration signal which is generated from conversion of a digital input signal comprising N samples to an analog signal, wherein said digital input signal comprises one (1) full scale sample and N-1 zero samples and N is an integer; and
in response to said receiving of said calibration signal, generating an output analog signal at said filter, wherein:
said output analog signal is converted to an output digital signal; and
a transfer function of said filter is determined via a Fast Fourier transformation of said output digital signal.

2. The method according to claim 1, wherein said OFDM system is compliant with one or more wireless standards comprising UMTS EUTRA (LTE), WiMAX(IEEE 802.16), and WLAN (IEEE 802.11).

3. The method according to claim 1, comprising measuring a transfer function of an in-phase branch filter and/or a quadrature branch filter.

4. The method according to claim 1, wherein said filter is an in-phase branch filter or a quadrature branch filter.

5. The method according to claim 1, wherein said transfer function comprises a magnitude and/or phase response.

6. The method according to claim 5, wherein said magnitude and/or phase response mismatch is a function of frequency.

7. The method according to claim 1, wherein a number of said samples N is chosen arbitrarily.

8. The method according to claim 1, wherein said calibration signal approximates an impulse signal.

9. The method according to claim 1, comprising performing said Fast Fourier transform with an arbitrary number of coefficients.

10. The method according to claim 1, comprising sampling output of said filter in response to said receiving of said calibration signal.

11. A system for processing signals in an OFDM system, the system comprising:
one or more circuits comprising a filter, wherein said one or more circuits enable:
reception of a calibration signal at said filter, wherein said calibration signal is generated from conversion of a digital input signal comprising N samples to an analog signal, wherein said digital input signal comprises one (1) full scale sample and N-1 zero samples and N is an integer; and
generation of an output analog signal at said filter in response to said reception of said calibration signal, wherein:
said output analog signal is converted to an output digital signal; and
a transfer function of said filter is determined via a Fast Fourier transformation of said output digital signal.

12. The system according to claim 11, wherein said OFDM system is compliant with one or more wireless standards comprising UMTS EUTRA (LTE), WiMAX(IEEE 802.16), and WLAN (IEEE 802.11).

13. The system according to claim 11, wherein said one or more circuits measure a transfer function of an in-phase branch filter and/or a quadrature branch filter.

14. The system according to claim 11, wherein said filter is an in-phase branch filter or a quadrature branch filter.

15. The system according to claim 11, wherein said transfer function comprises a magnitude and/or phase response.

16. The system according to claim 15, wherein said magnitude and/or phase response mismatch is a function of frequency.

17. The system according to claim 11, wherein a number of said samples N is chosen arbitrarily.

18. The system according to claim 11, wherein said calibration signal approximates an impulse signal.

19. The system according to claim 11, wherein said one or more circuits perform said Fast Fourier transform with an arbitrary number of coefficients.

20. The system according to claim 11, wherein said one or more circuits are operable to sample said output of said filter in response to said receiving of said calibration signal.
